(19) United States
(12) Patent Application Publication
(10) Pub. No.: US 2009/0220135 A1
(43) Pub. Date: Sep. 3, 2009

(54) SYSTEM, SERVER, METHOD AND PROGRAM FOR IMAGE TRANSFER

(76) Inventor: Keigo NAKAMURA, Tokyo (JP)

Correspondence Address: BIRCH STEWART KOLASCH & BIRCH, PO BOX 747, FALLS CHURCH, VA, 22040-0747, US

(21) Appl. No.: 12/395,337

(22) Filed: Feb. 27, 2009

(30) Foreign Application Priority Data
Feb. 28, 2008 (JP) 047480/2008
Feb. 27, 2009 (JP) 044991/2009

(51) Int. Cl. G06K 9/00; G06F 15/16

(52) U.S. Cl. 382/128; 709/231; 382/154

(57) ABSTRACT

When an image group to be displayed and compared is transferred to a terminal during viewing and processing of an image in an image group on the terminal that enables viewing of a plurality of image groups, an image corresponding to the currently displayed image is promptly transferred and displayed. In response to determination of the image group to be displayed and compared with the image group currently displayed on the terminal, a server determines the image that belongs to the image group to be displayed and compared and corresponds to the image in the image group being displayed, and determines a range and order of transfer of images that are to be transferred and include the corresponding image in the determined image group. The server transfers the determined image group according to the range and order of transfer.

### BACKGROUND OF THE INVENTION

1. Field of the Invention

The present invention relates to a system comprising a server storing a plurality of groups of digital images and a terminal that is connected communicably to the server and displays an image transferred from the server. The present invention also relates to the server, a method, and a program for the system.

2. Description of the Related Art

At the time of examination and image processing of a first group of images comprising medical tomographic images or the like such as CT images or MRI images, a second group of images such as MRI images corresponding to the first group of images are generally displayed in parallel for reference.

Images belonging to the same group generally have common characteristics. Therefore, after an examiner has completed examination or processing of an image in a first image group, the examiner repeats examination and processing of another image in the first group by display thereof, to complete examination or processing of all images in the group. During display and comparison of an image of a first group and an image of a second group, if another image in the first group is displayed, display of a corresponding image in the second group is desired.

For such a case, a method has been proposed in Japanese Patent No. 3639030 wherein an image in a second group corresponding to an image in a first group is automatically determined and displayed in response to display of the image in the first group.

However, in the case where the method described in Japanese Patent No. 3639030 is adopted in a general digital image transfer and display system that stores image groups in a server and transfers the image groups to a terminal for display, the image groups to be displayed for comparison are supposed to have been stored in the terminal before examination thereof.

For this reason, in order to take advantage of the invention described in Japanese Patent No. 3639030, image groups that are necessary for display and comparison need to be all specified in advance, and no examination or processing of the image groups can unfortunately be started before all images in the image groups are transferred to a terminal. In addition, in the case of medical image interpretation, physicians wish to display and compare relevant images in a second group on a terminal only if necessary after examining a first image group alone. Therefore, if all images in a second group are transferred from the very beginning as has been described above, examiners and systems are burdened with unnecessary transfer time and load. Moreover, in the case where a second image group becomes necessary during interpretation of a first image group alone, images in the second group are always transferred sequentially from the first image therein. Consequently, it is time-consuming for an image in the second group corresponding to an image in the first group being displayed on a terminal to be transferred to the terminal. Before completion of the transfer, the image cannot be displayed and compared, which is troublesome.

### SUMMARY OF THE INVENTION

The present invention has been conceived based on consideration of the above circumstances. An object of the present invention is therefore to provide an image transfer system, a transfer method, and a server and a program therefore that enable efficient transfer and display of a second image group to be displayed on a terminal for comparison with an image in a first image group being displayed on the terminal, in consideration of transfer waiting time for a viewer and a transfer load on the system.

An image transfer system of the present invention is an image transfer system comprising a server that stores groups of digital images and a terminal that is connected communicably to the server and displays an image transferred from the server. The system is characterized in that the server stores the groups of images, determines a second one of the image groups corresponding to a first one of the image groups including an image being displayed on the terminal, determines at least one image belonging to the second group and corresponding to the currently displayed image of the first group, determines in what order images in the second group are transferred based on the at least one image having been determined, and transfers the images to the terminal in the order having been determined.

The second image group corresponding to the first image group refers to an image group to be displayed for comparison, for diagnosis regarding the first image group. For example, the second image group refers to an image group of the same patient, or an image group of the same patient and the same modality.

The at least one image belonging to the second group and corresponding to the image being displayed on the terminal refers to an image to be displayed on the terminal for comparison with the image in the first group being displayed on the terminal. For example, the at least one image refers to an image or images belonging to the second group and representing the same anatomical position as the currently displayed image of the first group, or to an image or images belonging to the second group and having been radiographed or photographed in the same direction as the currently displayed image in the first group.

According to the image transfer system of the present invention, in the case where the second image group stored in the server is transferred to and displayed on the terminal for comparison and reference during display of the image in the first group on the terminal, the images in the second group are transferred serially starting from the image or images corresponding to the image in the first group currently displayed on the terminal. Therefore, the waiting time for display of the image or images for comparison can be shortened.

### BRIEF DESCRIPTION OF THE DRAWINGS

FIG. 1 is a schematic block diagram showing the configuration of a data transfer system of a first embodiment of the present invention;

FIG. 2 shows slice images obtained by CT in the first embodiment;

FIG. 3 is a flow chart showing the processing carried out in the data transfer system of the first embodiment;

FIG. 4 shows an example of a table storing which images in a series D1 are related to which images in a series D0 in the first embodiment;

FIG. 5 is a schematic block diagram showing the configuration of a data transfer system of a second embodiment of the present invention; and

FIG. 6 is a flow chart showing the processing carried out in the data transfer system in the second embodiment.

### DESCRIPTION OF THE PREFERRED EMBODIMENTS

Hereinafter, embodiments of the present invention will be described in detail, with reference to the accompanying drawings.

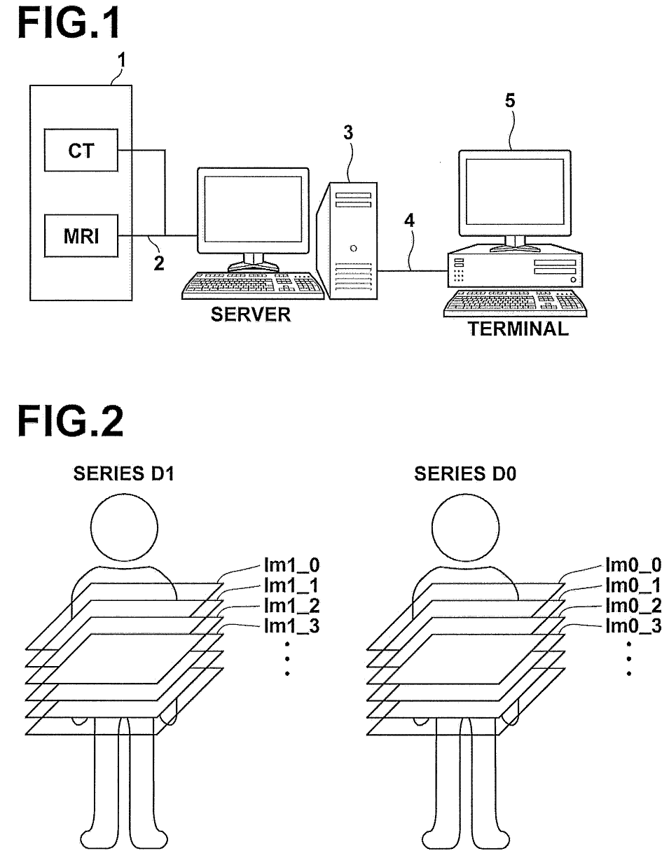

FIG. 1 is a schematic block diagram showing the configuration of a data transfer system of a first embodiment of the present invention. As show in FIG. 1, the data transfer system in the first embodiment is a medical network system used in the field of medicine, and comprises input modalities 1, an image server 3, and an image display terminal 5. The input modalities 1 are CT and MRI apparatuses that record image data sets. The image server 3 is connected to the input modalities 1 via a network 2, and stores groups of images recorded by the input modalities 1. The image display terminal 5 is connected to the image server 3 via a network 4.

In this embodiment, the image groups are groups of tomographic images obtained by CT, and each of the groups is referred to as a series. A series D0 and a series D1 have been obtained by radiographing the same patient at different times, and the series D0 is older than the series D1. As shown in FIG. 2, the series D0 and D1 respectively comprise slice images Im0_0, Im0_1, Im0_2, and so on and Im1_0, Im1_1, Im1_2, and so on. The images in each of the image groups are tomographic images radiographed in this order from the side of the head toward the side of the lower limbs.

The general flow of image comparison interpretation will be described first. In the environment described above, a physician transfers all the images in the series D1 to be interpreted, from the image server 3 to the image display terminal 5. Thereafter, the physician sequentially displays the slice images in the series D1 one by one to search for a shadow that may represent abnormality. In the case where the shadow has been found in one of the images, the physician judges whether the shadow is harmful or benign, based on the image alone. If the judgment is difficult by using the image alone, the physician transfers the series D0 to the terminal 5 in the case where the series D0 of the same patient obtained for the same body part by the same modality are available. The physician then displays the slice image belonging to the series D0 and representing the same anatomical position as the image showing the shadow in the series D1, together with the image showing the shadow. The physician judges whether a similar shadow is shown in the image in the series D0. In the case where the similar shadow has been found, the physician judges whether the shadow is malignant or benign, based on how the shadow has changed in size thereof, for example.

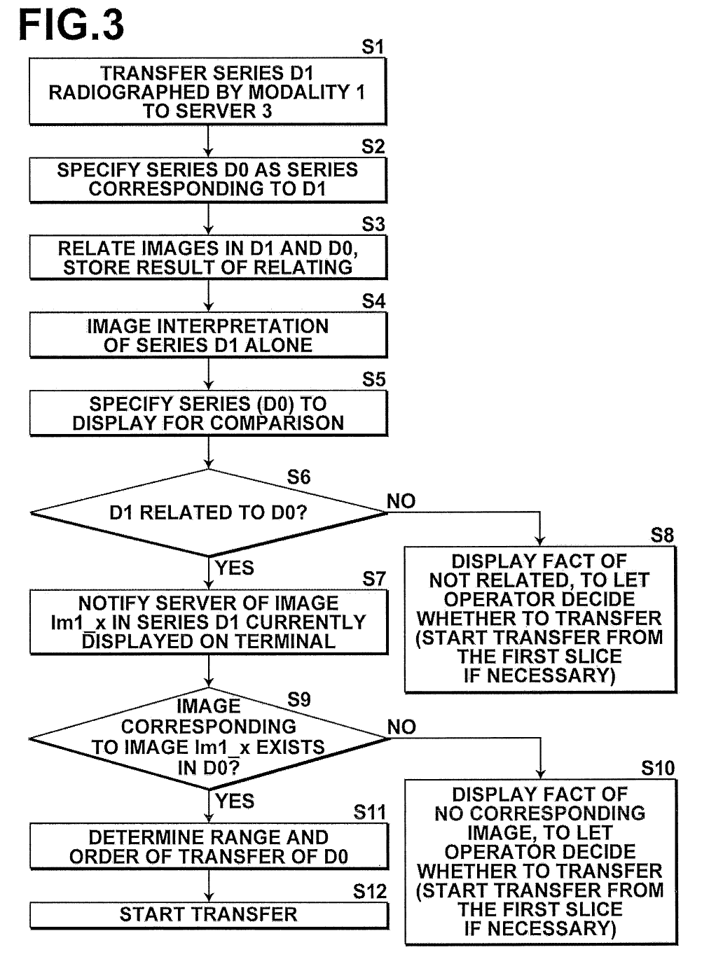

The operation of the first embodiment in the situation described above will be described below. FIG. 3 is a flow chart showing the processing carried out in the data transfer system of the first embodiment. Assume that the series D0 of the CT images recorded by one of the input modalities 1 has been stored in the image server 3.

At Step S1, the series D1 of the CT images radiographed by one of the input modalities 1 is transferred to the server 3.

At Step S2, the series to correspond to the series D1 is determined. A radiographer of the series D1 searches the server 3 for the series corresponding to the series D1, and specifies the series D0 of the same patient radiographed by the same input modality.

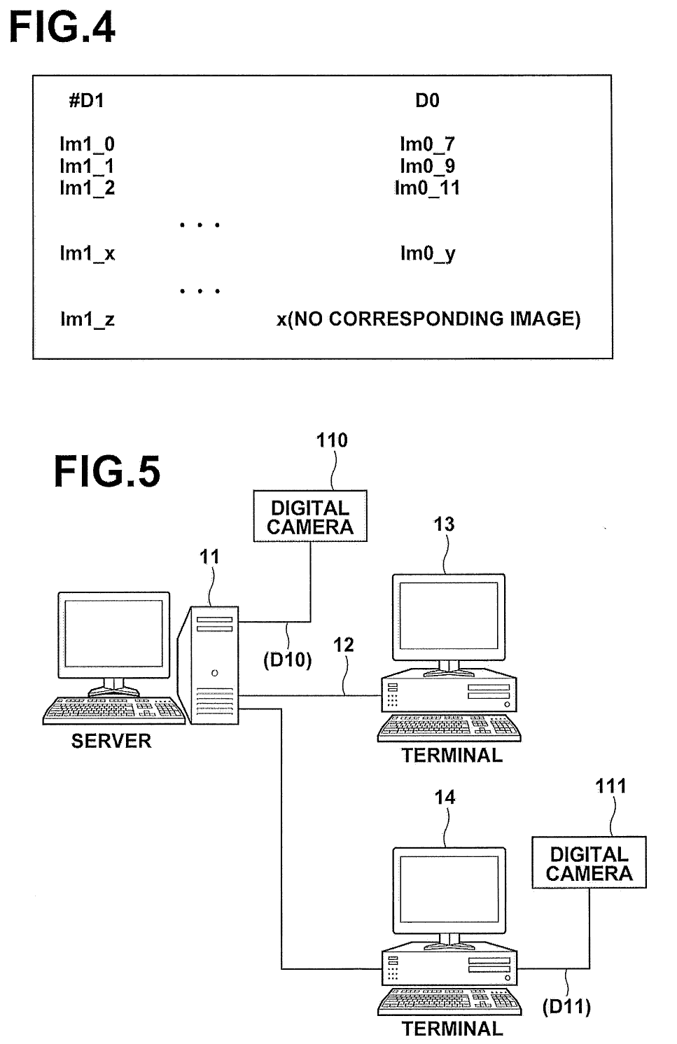

After the corresponding group (that is, the series) D0 has been determined at Step S2, the images are related to each other between the series D0 and the series D1 at Step S3. At this time, a similarity is found between each of the images Im1_0, Im1_1, Im1_2, and so on of the series D1 and each of the images Im0_0, Im0_1, Im0_2, and so on in the series D0, and each combination of the images between which the similarity is highest is judged to be the images representing substantially the same anatomical position. The combinations are stored in the form of a table as shown in FIG. 4. To find the similarity, a sum of differences or a correlation coefficient may be used. Although the corresponding images are simply determined based on the combinations of the images of highest similarity, a correction may be applied in consideration of continuous slicing positions.

The steps described above have been completed before a physician carries out interpretation of the images at the subsequent steps.

At Step S4, the physician specifies the series D1 for interpretation of the images in the series D1 alone while using the terminal 5, and transfers all the images of the series from the server 3 to the terminal 5. The physician displays the first image Im1_0, and continues to carry out image interpretation by display of a subsequent one of the images Im1_1 and son on in the same series D1 if no images of other series are necessary for reference.

In the case where the physician judges that comparison with an image obtained in the past is necessary for interpretation while interpreting an image Im1_{—}x in the series D1 at Step S4, the physician searches for the series radiographed in the past. The physician then instructs the server 3 to transfer the series to the terminal 5 (Step S5).

At Step S6, whether the series D1 has been related to the series D0 is confirmed. In the case where the series D1 has not been related to the series D0, the server 3 starts transfer of the series D0 starting from the first slice image (Step S8).

In the case where the series D1 has been related to the series D0, the server is notified that the series to be transferred to the terminal 5 is the series D0 and that the image being displayed on the terminal 5 is the image Im1_{—}x belonging to the series D1 (Step S7).

At Step S9, the server 3 determines one of the images that belongs to the series D1 and corresponds to the image Im1_{—}x, based on the information obtained at Step S7 and a result of relating at Step S3. Assume that an Image Im0_{—}y has been determined to be the corresponding image. In the case where none of the images in the series D0 has been judged to correspond to the image Im1_{—}x, the fact is displayed on a screen of the terminal 5 to cause the physician to select whether or not to transfer the series D0 to the terminal 5 (Step S10).

After the corresponding image has been determined, in what order the images in the series D0 are transferred from the server 3 to the terminal 5 is determined at Step S11. In this case, the images are transferred in the order starting from the image Im0_{—}y determined at Step S7 followed by Im0_(y+1), Im0_(y−1), Im0_(y+2), Im0_(y−2), and so on that are closer to the image Im0_{—}y. In this example, all the images in the series D0 are transferred without limiting a range of the transferred images. However, the transfer range may be set in advance in a menu screen or the like so that only a portion of the images corresponding to the range in the series D0 can be transferred. As a method of setting the transfer range, a method of specifying the quantity such as “20 images around the corresponding image” or a method of specifying an actual distance such as “slice images within 20 mm from the corresponding image” may be used.

At Step S12, the images are finally transferred to the terminal 5 according to the order determined at Step S11. The terminal 5 displays the image Im0_{—}y immediately upon completion of transfer of the image.

As has been described above, according to this embodiment, when the series D0 corresponding to the series D1 being displayed on the terminal 5 is transferred from the server 3, the series D0 is transferred starting from the image corresponding to the image being displayed on the terminal. Therefore, the physician carrying out image interpretation on the terminal 5 can display and compare the image for interpretation after waiting for transfer of only the corresponding image. In addition, if the transfer range is limited in the above manner, a transfer load can also be reduced.

In the first embodiment described above, the radiographer manually searches for and determines the corresponding series at Step S3. However, a relationship between the series to be related to each other may be preset so that the corresponding series can be determined automatically according to a condition representing the relationship. For example, the condition may be set to relate the series of the same patient obtained by the same modality so that the system can determine that the series D1 is related to the series D0 at the time the series D1 is transferred to the server 3. Furthermore, the system may be set to relate series of the same patient obtained by different modalities. Moreover, a condition other than the patient and the modalities may also be used to determine the necessity of relating.

In the first embodiment, the images are related to each other at Step S3, and the result is stored. However, an apparatus to manually correct the result may be incorporated. In this manner, the case where the result of relating is wrong can be dealt with, and the result can also be deleted in the case where no corresponding image exists due to different radiography ranges between the series.

In the embodiment described above, the combinations with the corresponding images in the series D0 are found for all the images in the series D1 at Step S3. However, the combination may be found for only one of the images so that the remaining images can be related based on the combination. Tomographic images radiographed by modalities such as CT and MRI are obtained at predetermined slicing intervals, and the intervals can be easily obtained in many cases. Therefore, once the image in the series D0 corresponding to one of the images in the series D1 is found and the combination is stored, the images corresponding to the remaining images in the series D1 can also be found easily in the series D0. For example, based on image relating information that an image Im1_{—}j in the series D1 corresponds to an image Im0_{—}k in the series D0 and information that the slicing intervals are 2 mm for the series D1 while the intervals are 1 mm for the series D0, an image Im1_{—}j+n can be easily related to an image Im0_{—}k+2n. In this manner, the corresponding images may be found according to the relating information of one combination and the slicing interval information.

In the embodiment described above, the series corresponding to the series D1 is searched for manually by the physician to specify the series D0 at Step S4. However, without direct specification of the series D0, the series may be determined according to a preset rule. In this case, the relationship between the series to be regarded as the corresponding series is specified in advance in a setting screen or the like. For example, in the case where the system has been set to relate the series of the same patient obtained by the same modality, the corresponding image group can be transferred in the determined order of the images by a simple click of a “Compare” button during image interpretation. In the case where a plurality of image groups are related to each other, the order of transfer may be determined by collectively combining images whose transfer has been determined among the image groups. For example, assume that series D2 and D3 correspond to the series D1 being displayed on the terminal 5 and the series D3 was radiographed before the series D2. In the case where an image Im2_{—}y in the series D2 and an image Im3_{—}z in the series D3 have been judged to correspond to the image Im1_{—}x being displayed on the terminal 5, the order of transfer from the server 3 may be determined as Im2_{—}y, Im3_{—}z, Im2_(y+1), Im3_(z+1), Im2_(y−1), Im3_(z−1), Im2_(y+2), Im3_(z+2), Im2_(y−2), Im3_(z−2), and so on.

In the above embodiment, the image transfer starts by manual specification of the series D0 at Step S5. However, the transfer may be started automatically through judgment of a state of the terminal. For example, in the case where no operation has been carried out for a certain amount of time during interpretation of an image Im1_{—}a of the series D1 on the terminal 5, the system may start transfer of the series that has been automatically determined to correspond to the series D1 in the order starting from and closer to an image corresponding to the image Im1_{—}a. Consequently, at the time of manual instruction by the physician (an operator of the terminal) to transfer the images for comparison, a portion or all of the necessary images has/have been transferred to the terminal. Therefore, the time necessary for display of the images for comparison can be shortened further, which leads to improvement in efficiency of image interpretation. Moreover, if the system checks a state of communication path to determine the timing of the transfer, efficiency of communication load can also be improved.

In the above embodiment, the order of transfer of the images in the series D0 has been determined as the order starting from and closer to the image Im0_{—}y at Step S11. However, the image that is going to be necessary may be judged and prioritized in determination of the order, based on a history of display of the series D1 on the terminal 5 at Steps S4 and S5. For example, in the case where the image interpretation of the series D1 has been carried out at Steps S4 and S5 in sequential order such as Im1_0, Im1_1, . . . and Im1_{—}x starting from the side of the head toward the side of the lower limbs without returning, the images preceding the image Im1_{—}x may be judged to have been interpreted. In this case, the order of transfer of the series D0 for reference is determined as Im0_{—}y, Im0_(y+1), . . . Im0_End (the last slice), Im0_(y−1), Im0_(y−2), Im0_(y−3), . . . and Im0_0 (the first slice).

In the example described above, the CT images are used. However, the same processing can be carried out on images of MRI (Magnetic Resonance Imaging) or PET (Positron Emission Tomography), for example. If mutual information is used to calculate the similarity, images obtained by different modalities such as CT and MRI can be related to each other. Therefore, the present invention can be effective for display and comparison of the images obtained by different modalities.

In addition, not only for the case of tomographic images such as CT or MRI images but also for the case where frontal or side images of CR or DR are stored as one series, the present invention is likewise effective.

The operation of a second embodiment of the present invention will be described next.

FIG. 5 is a schematic block diagram showing the configuration of a data transfer system of the second embodiment. As shown in FIG. 5, the data transfer system of the second embodiment is a network system for digital images, and comprises an image server 11 and an image display/correction terminal 13. The image server 11 stores groups of digital images obtained by photography of the same main subject (such as a person) in the same time period by a plurality of digital cameras. The image display/correction terminal 13 is connected to the image server 11 via a network 12.

In this embodiment, one image group refers to images obtained by one digital camera and is called as a series. Series D10 and D11 respectively comprise images obtained by a digital camera 110 and by a digital camera 111 in the same time period and at the same place. The series D10 includes images Im10_1, Im10_2, Im10_3, and so on while the series D11 includes images Im11_1, Im11_2, Im11_3, and soon. In each of the series, the images have been sorted in ascending order of photography time. Assume that image data of the series include not only pixel value information but also information on the time of acquisition of each of the images.

In image correction processes that will be described below, an operator targets all the images obtained by the digital camera 110. The operator firstly transfers all the images in the series D10 from the server 11 to the terminal 13. The operator displays one of the images in the series D10 to carry out desired image processing thereon. After completion of the image processing, the operator carries out image processing on a subsequent one of the images in the series. By repeating the processes, the operator carries out appropriate image processing on all the images in the series, and stores the images having subjected to the processing in the server 11. As the image processing, red-eye correction and dynamic range compression may be carried out, for example. If the image processing to be carried out can be determined solely based on the image being displayed, the processing can be determined without a problem. However, if appropriate image processing is not known due to the fact that a structure of the subject in the image being displayed is not easily viewed in detail, for example, the same subject is highly likely to have been photographed in a corresponding one of the images obtained by the digital camera 111 at a time close to the time of photography of the currently displayed image. Therefore, by referring to the image photographed by the digital camera 111, the appropriate image processing can be determined.

The images obtained by the digital camera 110 are transferred directly to the server 11 to be stored therein. The images obtained by the digital camera 111 are transferred to the server 11 via a terminal 14, and stored therein.

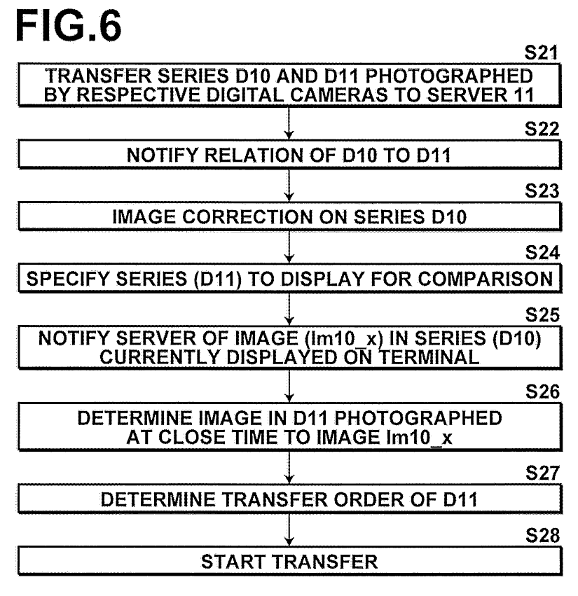

The operation of the second embodiment in the above situation will be described below. FIG. 6 is a flow chart showing the processing carried out in the data transfer system in the second embodiment.

The images obtained by the two cameras are respectively stored as the series D10 and D11 in the server 11 at Step S21.

At Step S22, the operator having transferred the images from the digital cameras to the server 11 notifies the server 11 that the series D10 and D11 have been obtained in the same time period and at the same place.

At Step S23, the operator transfers all the images in the series D10 from the server 11 to the terminal 13 for image processing, and starts correction by using the images in the series D10 alone. At Step S23, the operator carries out appropriate image processing on one of the images in the series D10. In the case where the image processing to be carried out has been determined based on the image alone, the operator carries out the processing and thereafter targets a subsequent one of the images. At the time of completion of image processing on the last image after repeating the processes, the processing ends.

In the case where the image processing to be carried out on an image Im10_{—}x in the series D10 has not been determined at Step S23 based on the image alone, the operator specifies the series D11 photographed by the other digital camera in the same time period and at the same place (Step S24). Although the operator searches for and specifies the series D11 in this case, a “Different Camera Images” button may be disposed on a screen so that the system can automatically search for and specify the series D11 corresponding to the currently displayed series D10 in response to a click on the button.

At Step S25, the time of acquisition of the image Im10_{—}x being displayed on the terminal 13 is transferred to the server 11 together with the information of the series D11 specified at Step S24.

At Step S26, a corresponding one of the images obtained at the closest time to the acquisition time transferred from the terminal 13 at Step S25 is determined in the series D11. Assume that the image is Im11_{—}y.

At Step S27, in what order the images are transferred is determined regarding the series D11. The server 11 determines the order as Im11_{—}y, Im11_(y+1), Im11_(y−1), Im11_(y+2), Im11_(y−2), and so on. Although all the images in the series D11 are transferred in this case without limiting a range of the transfer, the transfer range may be set in advance in a menu screen or the like. In this case, a corresponding portion of the images to the range in the series D11 is transferred. As a method of setting the transfer range, a method of specifying the quantity such as “20 images around the corresponding image in order of closer acquisition time” or a method of specifying the acquisition time such as “images obtained within 30 minutes from the acquisition time of the corresponding image” may be used.

At Step S28, the images in the series D11 are finally transferred to the terminal 13 in the order determined at Step S27. The terminal 13 displays the image Im11_{—}y as soon as the image has been transferred thereto, without waiting for transfer of the remaining images.

As has been described above, according to this embodiment, when the images in the series D11 corresponding to the series D10 being displayed on the terminal 13 are transferred from the server 11, the images are transferred in the order of closer acquisition time to the image being displayed on the terminal. Therefore, the operator viewing and processing the images on the terminal 13 can determine the image processing through comparison of the images, after waiting for transfer of only the corresponding image. In addition, in the case where the transfer range has been preset, a transfer load caused by transferring an unnecessary portion of the images can be avoided.

In this embodiment, the images in each of the series are arranged in the ascending order of photography time, and the image closer in the acquisition time to the image currently displayed on the terminal is more prioritized in the transfer order. However, information specifying the subject may be used instead of the acquisition time. For example, specific characteristic quantities may be extracted in advance from the images and stored so that an image whose characteristic quantities are closer to those of the image being displayed on the terminal can be more prioritized in the transfer order.

What is claimed is:

1. An image transfer system comprising a server and a terminal that is connected communicably to the server and displays an image transferred from the server, wherein the server
stores groups of images;
determines a second one of the image groups corresponding to a first one of the image groups including an image being displayed on the terminal;
determines at least one image belonging to the second group and corresponding to the currently displayed image of the first group;
determines in what order images in the second group are transferred, based on the at least one image having been determined; and
transfers the images in the second group to the terminal in the order having been determined.

2. The image transfer system according to claim 1, wherein the order of transfer is the order of closer three-dimensional position to the at least one image in the second group.

3. The image transfer system according to claim 1, wherein the system comprises means for manually correcting a result of the images corresponding to each other.

4. The image transfer system according to claim 1, wherein the corresponding second image group is determined by being specified by an operator of the terminal.

5. The image transfer system according to claim 1, wherein the corresponding second image group is determined automatically according to a preset rule.

6. The image transfer system according to claim 1, wherein the at least one corresponding image is determined by
relating in advance at least one pair of images between the image groups and
by relating thereafter other images between the image groups based on a result of the relating of the at least one pair.

7. The image transfer system according to claim 6, wherein the relating of the images is carried out according to a similarity between the images in the image groups.

8. The image transfer system according to claim 1, wherein the at least one corresponding image is determined by relating in advance all images between the image groups and
by determining the at least one corresponding image based on a result of the relating.

9. The image transfer system according to claim 8, wherein the relating of the images is carried out according to a similarity between the images in the image groups.

10. The image transfer system according to claim 1, wherein the at least one corresponding image is determined based on order of photography time of the images.

11. The image transfer system according to claim 1, wherein the at least one corresponding image is determined based on information that specifies a subject of each of the images.

12. The image transfer system according to claim 1, wherein the images are medical images and the at lest one corresponding image is determined by relating images representing substantially the same anatomical position in the medical images.

13. The image transfer system according to claim 1, wherein the order of transfer is determined based on the at least one corresponding image in the second image group and on either a display history or an operation history regarding the first image group on the terminal.

14. The image transfer system according to claim 1, wherein the transfer to the terminal is carried out automatically after no operation has been carried out for a predetermined amount of time on the terminal.

15. The image transfer system according to claim 1, wherein the system further determines a range of transfer of the images at the time of determination of the order of transfer, and
transfers a portion of the images corresponding to the transfer range according to the order of transfer.

16. A server that transfers an image to a terminal that displays the image, wherein the server has functions:
to store groups of images;
to determine a second one of the image groups corresponding to a first one of the image groups including an image being displayed on the terminal;
to determine at least one image belonging to the second group and corresponding to the currently displayed image of the first group;
to determine in what order images in the second group are transferred, based on the at least one image having been determined; and
to transfer the images in the second group to the terminal in the order having been determined.

17. An image transfer method for transferring groups of images from a server that stores the image groups to a terminal connected communicably to the server, the method comprising the steps of:
determining a second one of the image groups corresponding to a first one of the image groups including an image being displayed on the terminal;
determining at least one image belonging to the second group and corresponding to the currently displayed image of the first group;
determining in what order images in the second group are transferred, based on the at least one image having been determined; and
transferring the images in the second group to the terminal in the order having been determined.

18. A computer-readable recording medium storing a program causing a server that stores a plurality of series of image groups each comprising a plurality of images and a terminal that displays at least one of the images in at least one of the series of image groups to execute the procedures of:
determining a second one of the image groups stored in the server and related to a first one of the image groups being displayed on the terminal;
determining at least one image belonging to the second group and corresponding to the currently displayed image of the first group;
determining in what order images in the second group are transferred, based on the at least one image having been determined; and
transferring the images in the second group to the terminal in the order having been determined.

19. The image transfer system according to claim 7, wherein the system comprises means for manually correcting a result of the relating of the images.

20. The image transfer system according to claim 9, wherein the system comprises means for manually correcting a result of the relating of the images.
